(19) United States
(12) Patent Application Publication
(10) Pub. No.: US 2008/0059201 A1
(43) Pub. Date: Mar. 6, 2008

(54) Method and Related Device for Improving the Processing of MP3 Decoding and Encoding

(76) Inventor: Chih-Hsiang Hsiao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/469,876

(22) Filed: Sep. 3, 2006

(51) Int. Cl. G10L 21/00

(52) U.S. Cl. 704/500

(57) ABSTRACT

A method for improving the processing of MP3 decoding includes decoding Huffman encoded data into audio samples according to side information, determining a first group of audio samples having a predefined audio characteristic outside a range running from a first predetermined value to a second predetermined value inclusive, determining a second group of audio samples having the predefined audio characteristic inside said range, and performing fewer arithmetic operations on the first group of audio samples than on the second group of audio samples. Performing fewer arithmetic operations on the first group of audio samples than on the second group of audio samples includes no subsequent arithmetic operations are performed on the first group of audio samples or fewer bits are utilized to represent the first group of audio samples than to represent the second group of audio samples.

### BACKGROUND OF THE INVENTION

1. Field of the Invention

The present invention relates to a method and related device for improving the processing of MP3 decoding and encoding, and more particularly, to a method and related device that utilizes a first operation simplification detector to select subsequent arithmetic operations applied to a group according to a predefined audio characteristic of the group.

2. Description of the Prior Art

As information technology has increasingly become digital, electronic devices have developed rapidly. Additionally, as digital technology has become prevalent, hand-held devices have become more and more portable. Examples of such hand-held devices are MP3 (Moving Picture Experts Group, MPEG1, layer 3) players, and personal disks, etc. Due to the popularity of digital music, MP3 players as well as other types of music players can be found everywhere.

MP3 is a popular digital audio encoding and lossy compression format standardized by a team of engineers in Germany. It was designed to greatly reduce the amount of data required to represent audio. In popular usage, MP3 also refers to files of sound or music recordings stored in the MP3 format on computers. MP3 is a standard of audio coding with high quality and high efficiency. It provides a representation of pulse-code modulation-encoded (PCM) audio data in a much smaller size by discarding portions that are considered less important to human hearing. A number of techniques are employed in MP3 to determine which portions of the audio can be discarded, such as a psychoacoustics model. MP3 audio can be compressed with different bit rates, providing a range of tradeoffs between data size and sound quality.

Decoding of MP3 audio is defined in the MPEG-1 standard. Most decoders are bit-stream compliant. The MP3 file has a standard format which is a frame consisting of 384, 576, or 1152 samples (depends on MPEG version and layer). All the frames have associated header information (32 bits) and side information. The header and side information help the decoder to decode the associated Huffman encoded data correctly. Therefore, comparison of decoders is almost based on how computationally efficient they are.

The MPEG-1 standard does not include a precise specification for an MP3 encoder. Implementers of the standard were supposed to devise their own algorithms suitable for removing parts of the information in the raw audio. When quantizing, bit-allocation is decided according to a psychoacoustics model that is the study of human acoustic perception (in both the ear and in the brain). There are many different MP3 encoders available, each producing files of different quality. Comparisons are widely available, so it is easy for a prospective user of an encoder to research the best choice.

In the prior art, an MPEG-1 audio layer 3 decoding device includes a bit stream decomposing portion for decomposing an input bit stream of MP3 into side information, a scale factor and Huffman code data; a scale factor decoder for decoding the scale factor; a Huffman decoder for decoding the Huffman code data; an inverse quantizer for performing inverse quantizing processing on the Huffman code data based on the side information, the scale factor and the Huffman code data; and a hybrid filter bank portion for inversely mapping and decoding the output of the inverse quantizer into a time region signal.

Please refer to FIG. 1. FIG. 1 is a flowchart 10 showing decoding processing for the audio data portion of MP3 according to the prior art.

The flowchart 10 includes the following steps.

Step 102: Start.

Step 104: Extraction and analysis of header.

Step 106: Side information decoding.

Step 108: Scale factor decoding.

Step 110: Huffman code data decoding.

Step 112: Inverse quantization.

Step 114: Butterfly operation.

Step 116: IMDCT operation.

Step 118: PFB.

Step 120: PCM data output.

Step 122: End.

The bit stream decomposing portion extracts and analyzes the header of the received bit string (Step 104). The bit stream decomposing portion decodes the side information, and extracts the Huffman code data and scale factor (Step 106). The scale factor decoder decodes the scale factor based on the side information (Step 108). The Huffman decoder decodes the Huffman code data based on the side information (Step 110). The inverse quantizer inversely quantizes the Huffman code data based on the result of operation in steps 110. The butterfly operating portion performs the butterfly operation on the result of the inverse quantization obtained in step 112. The IMDCT operating portion performs the IMDCT processing in accordance with the result of processing in steps 114. The subband composing portion performs the subband composition using PFB on the operation result of IMDCT operating portion based on the result of processing in step 116, and issues PCM data which is a time region signal.

MP3 Decoding and Encoding applications are currently undergoing development. In U.S. Pat. No. 6,344,808 B1, Maiko Taruki et al. disclose a “MPEG-1 Audio Layer III Decoding Device Achieving Fast Processing by Eliminating an Arithmetic Operation Providing A Previously Known Operation Result”. In one embodiment, an MPEG-1 audio layer 3 decoding device, which can perform fast decoding of MP3 by performing fast de-quantization of Huffman code data is disclosed. The MPEG-1 audio layer 3 decoding device includes a bit stream decomposing portion for decomposing an input bit stream of MP3 into side information, a scale factor and Huffman code data; a scale factor decoder for decoding the scale factor; a Huffman decoder for decoding the Huffman code data; a zero detecting portion for detecting a band of the Huffman code data all providing values of zero; and inverse quantizer for performing inverse quantizing processing on the Huffman code data based on the output of the zero detecting portion, the side information, the scale factor and the Huffman code data; and a hybrid filter bank portion for inversely mapping and decoding the output of the inverse quantizer into a time region signal.

Please refer to FIG. 2. FIG. 2 is a flowchart 20 showing decoding processing for the audio data portion of MP3 according to Maiko Taruki et al.

The flowchart 20 includes the following steps:

Step 202: Start.

Step 204: Extraction and analysis of header.

Step 206: Side information decoding.

Step 208: Scale factor decoding.

Step 210: Huffman code data decoding.

Step 212: Zero detection 1 (is, flag_is).

Step 214: Zero detection 2.

Step 216: Inverse quantization.

Step 218: Butterfly operation.

Step 220: Zero detection 3 (X, flas_X).

Step 222: IMDCT operation.

Step 224: PFB.

Step 226: PCM data output.

Step 228: End.

The bit stream decomposing portion extracts and analyzes the header of the received bit string (Step 204). The bit stream decomposing portion decodes the side information, and extracts the Huffman code data and scale factor (Step 206). The scale factor decoder decodes the scale factor based on the side information (Step 208). The Huffman decoder decodes the Huffman code data based on the side information (Step 210). The zero detecting portion includes a first zero detector, a second zero detector, and a third zero detector. The first zero detector receives the Huffman code data from the Huffman decoder, and detects a band of the Huffman code data, in which all the values are equal to zero (Step 212). The second zero detector receives the Huffman code data from the Huffman decoder, and detects a band in which coding of MP3 is not performed (step 214). The inverse quantizer inversely quantizes the Huffman code data based on the result of operation in steps 212 and 214. The butterfly operating portion performs the butterfly operation on the result of the inverse quantization obtained in step 216 based on the result of processing in step 214. The third zero detector receives the result of the butterfly operation, and detects the band in which all the values of the result of the butterfly operation are equal to zero (Step 220). The IMDCT operating portion performs the IMDCT processing in accordance with the result of processing in steps 214 and 220. The subband composing portion performs the subband composition using PFB on the operation result of IMDCT operating portion based on the result of processing in step 214, and issues PCM data which is a time region signal. Processing from step 212 to step 224 are described in detail with reference to the U.S. Pat. No. 6,344,808 B1.

In the prior art MP3 decoding method, a filter-bank providing all values of zero is ignored. This can reduce a certain arithmetic operations, but zero searching spends extra time. On the other hand, the prior art MP3 encoding method focuses on speeding up the psychoacoustic model and bit-allocation device. But there are no methods for improving the processing of MP3 decoding by lowering arithmetic operations on the filter-bank and the quantizer.

### SUMMARY OF THE INVENTION

The claimed invention provides a method for improving the processing of MP3 decoding. The method includes decoding Huffman encoded data into audio samples according to side information, determining a first group of audio samples having a predefined audio characteristic outside a range running from a first predetermined value to a second predetermined value inclusive, determining a second group of audio samples having the predefined audio characteristic inside said range, and performing fewer arithmetic operations on the first group of audio samples than on the second group of audio samples.

The claimed invention provides an MP3 decoder capable of improving the processing of MP3 decoding. The MP3 decoder includes a bit stream decomposer, a scale factor decoder, a Huffman decoder, a first operation simplification detector, and a de-quantizer. The bit stream decomposer is used for decomposing an input bit stream of MP3 into side information, a scale factor and Huffman encoded data. The scale factor decoder has a first input end coupled to a first output end of the bit stream decomposer for receiving the scale factor and a second input end coupled to a second output end of the bit stream decomposer for receiving the side information. A first input end of the Huffman decoder is coupled to a third output end of the bit stream decomposer for receiving the Huffman encoded data, and a second input end of the Huffman decoder is coupled to the second output end of the bit stream decomposer for receiving the side information. A first input end of the first operation simplification detector is coupled to the second output end of the bit stream decomposer for receiving the side information and a second input end of the first operation simplification detector is coupled to a first output end of the Huffman decoder. The first operation simplification detector is used for selecting subsequent arithmetic operations applied to a group outputted from the Huffman decoder according to a predefined audio characteristic of the group. The de-quantizer has a first input end coupled to a second output end of the Huffman decoder, a second input end coupled to an output end of the scale factor decoder, a third input end coupled to an output end of the first operation simplification, and a fourth input end coupled to the second output end of the bit stream decomposer for receiving the side information.

The claimed invention provides a method for improving the processing of MP3 decoding. The method includes decoding Huffman encoded data according to side information, eliminating image linkage and outputting a plurality of filter-banks of audio samples, determining a first filter-bank of the plurality of filter-banks having a predefined audio characteristic less than a first predetermined value or greater than a second predetermined value, and performing fewer arithmetic operations on the first filter-bank than on a second filter-bank of the plurality of filter-banks having the predefined audio characteristic between the first predetermined value and the second predetermined value inclusive where the first predetermined value is less than the second predetermined value.

The claimed invention provides a method for improving the processing of MP3 encoding. The method includes synthesizing input PCM data into a plurality of filter-banks of audio samples, determining a first filter-bank of the plurality of filter-banks having a predefined audio characteristic less than a first predetermined value or greater than a second predetermined value, performing fewer arithmetic operations on the first filter-bank than on a second filter-bank of the plurality of filter-banks having the predefined audio characteristic between the first predetermined value and the second predetermined value inclusive, encoding the second filter-bank into a plurality of groups of audio samples, and determining quantities of bits utilized by each group of audio samples. The first predetermined value is less than the second predetermined value.

The claimed invention provides an MP3 encoder capable of improving the processing of MP3 encoding. The MP3 encoder includes a sub-band synthesizer, a psychoacoustic model, a first operation simplification detector, a second operation simplification detector, and an encoder. The sub-band synthesizer is used for synthesizing input PCM data into a plurality of filter-bank samples. The psychoacoustic model has an input end for receiving signal information. A first input end of the first operation simplification detector receives the signal information and a second input end of the first operation simplification detector is coupled to the output end of the psychoacoustic model. The second operation simplification detector includes an input end coupled to the sub-band synthesizer for selecting subsequent arithmetic operations applied to a filter-bank of the plurality of filter-bank samples according to a predefined audio characteristic of the filter-bank. A first input end of the encoder is coupled to the sub-band synthesizer and a second input end of the encoder is coupled to the output end of the first operation simplification detector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart showing decoding processing for the audio data portion of MP3 according to the prior art.

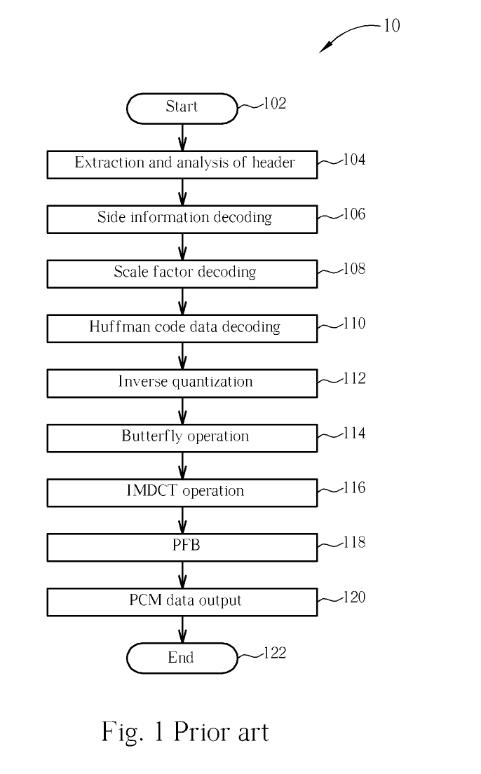

FIG. 2 is a flowchart showing decoding processing for the audio data portion of MP3 according to another prior art.

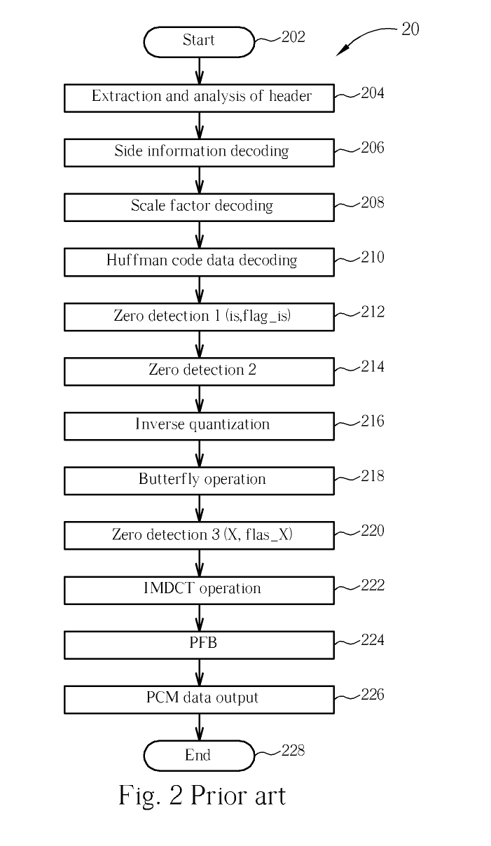

FIG. 3 is a diagram of an MP3 decoder according to an embodiment of the present invention.

FIG. 4 is a flowchart illustrating processing of MP3 decoding in FIG. 3.

FIG. 5 is a diagram of another MP3 decoder according to an embodiment of the present invention.

FIG. 6 is a flowchart illustrating processing of MP3 decoding in FIG. 5.

FIG. 7 is a diagram of an MP3 encoder according to the present invention.

FIG. 8 is a flowchart illustrating processing of MP3 encoding in FIG. 7.

### DETAILED DESCRIPTION

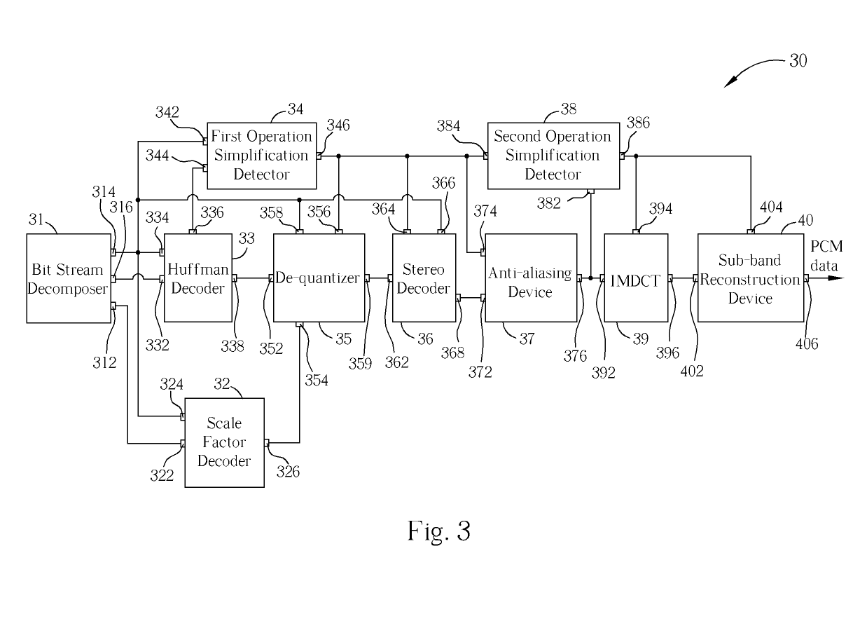

Please refer to FIG. 3. FIG. 3 is a diagram of an MP3 decoder 30 according to the present invention. The MP3 decoder 30 includes a bit stream decomposer 31, a scale factor decoder 32, a Huffman decoder 33, a first operation simplification detector 34, a de-quantizer 35, a stereo decoder 36, an anti-aliasing device 37, a second operation simplification detector 38, an IMDCT transformer 39, and a sub-band reconstruction device 40. The bit stream decomposer 31 is used for decomposing an input bit stream of MP3 into side information, a scale factor and Huffman encoded data. The bit stream decomposer 31 has a first output end 312 for outputting the scale factor, a second output end 314 for outputting side information, and a third output end 316 for outputting Huffman encoded data. The scale factor decoder 32 has a first input end 322 coupled to the first output end 312 of the bit stream decomposer 31 for receiving the scale factor and a second input end 324 coupled to the second output end 314 of the bit stream decomposer 31 for receiving the side information. A first input end 332 of the Huffman decoder 33 is coupled to the third output end 316 of the bit stream decomposer 31 for receiving the Huffman encoded data, and a second input end 334 of the Huffman decoder 33 is coupled to the second output end 314 of the bit stream decomposer 31 for receiving the side information. A first input end 342 of the first operation simplification detector 34 is coupled to the second output end 314 of the bit stream decomposer 31 for receiving the side information and a second input end 344 of the first operation simplification detector 34 is coupled to a first output end 336 of the Huffman decoder 33. The first operation simplification detector 34 is used for selecting subsequent arithmetic operations applied to a group outputted from the Huffman decoder 33 according to a predefined audio characteristic of the group.

The de-quantizer 35 has a first input end 352 coupled to a second output end 138 of the Huffman decoder 33, a second input end 354 coupled to an output end 326 of the scale factor decoder 32, a third input end 356 coupled to an output end 346 of the first operation simplification 34, and a fourth input end 358 coupled to the second output end 314 of the bit stream decomposer 31 for receiving the side information. A first input end 362 of the stereo decoder 36 is coupled to an output end 359 of the de-quantizer 35. A second input end 364 of the stereo decoder 36 is coupled to the output end 346 of the first operation simplification detector 34, and a third input end 366 is coupled to the second output end 314 of the bit stream decomposer 31. The anti-aliasing device 37 has a first input end 372 coupled to an output end 368 of the stereo decoder 36, a second input end 374 coupled to the output end 346 of the first operation simplification detector 34, and an output end 376 used to output a plurality of filter-bank samples. A first input end 382 of the second operation simplification detector 38 is coupled to the output end 376 of the anti-aliasing device 37 and a second input end 384 of the second operation simplification detector 38 is coupled to the output end 346 of the first simplification detector 34. The IMDCT transformer 39 has a first input end 392 coupled to the output end 376 of the anti-aliasing device 37 for receiving the filter-bank samples outputted from the anti-aliasing device 37 and a second input end 394 coupled to an output end 386 of the second operation simplification detector 38. The sub-band reconstruction device 40 has a first input end 402 coupled to an output end 396 of the IMDCT transformer 39, a second input end 404 coupled to the output end 386 of the second operation simplification detector 38, and an output end 406 for outputting a PCM data.

Please keep referring to FIG. 3. In the prior art, no operations are performed on only the group of audio samples providing all values of zero (so-called zero searching). But in this embodiment of our invention, the first operation simplification detector 34 can find out more groups of audio samples that are insensitive to a human ear or have no encoded data according to the side information. For example, if a frequency of a group of audio samples is less than 15 Hz or greater than 20000 Hz, which represents the frequency range insensitive to a human ear. Hence, the first operation simplification detector 34 regards the group of audio samples as insensitive to a human ear according to the side information. When de-quantizing, no operations are performed on the group of audio samples that is insensitive to a human ear (in this case, the frequency is less than 15 Hz or greater than 20000 Hz). When stereo decoding, no operations are performed on the group of audio samples that is insensitive to a human ear. When anti-aliasing, operations are performed on the group of audio samples that is insensitive to a human ear. Moreover, no operations are performed on the groups of audio samples that have no encoded data according to the side information when de-quantizing, stereo decoding, or anti-aliasing.

Please keep referring to FIG. 3. In the prior art, no operations are performed on only the plurality of filter-banks of audio samples providing all values of zero. But in this embodiment of our invention, the second operation simplification detector 38 can find out more filter-banks of audio samples that are insensitive to a human ear according to specific algorithms or have no encoded data according to the information from the first operation simplification detector 34. For example, if a frequency of a filter-bank of audio samples is less than 15 Hz or greater than 20000 Hz, which represents the frequency range insensitive to a human ear. Hence, the second operation simplification detector 38 regards the filter-bank of audio samples as insensitive to a human ear according to the side information. When performing inverse modified discrete cosine transformations, no operations are performed on the filter-bank of audio samples that is insensitive to a human ear (in this case, the frequency is less than 15 Hz or greater than 20000 Hz). Furthermore, when performing inverse modified discrete cosine transformations, fewer bits are used to represent the filter-bank of audio samples that is insensitive to a human ear. Moreover, no operations are performed on the filter-banks of audio samples that have no encoded data according to the information from the first operation simplification detector 34 when performing inverse modified discrete cosine transformations. By way of utilizing the first operation simplification detector 34 and the second operation simplification detector 38, we can reduce more operations.

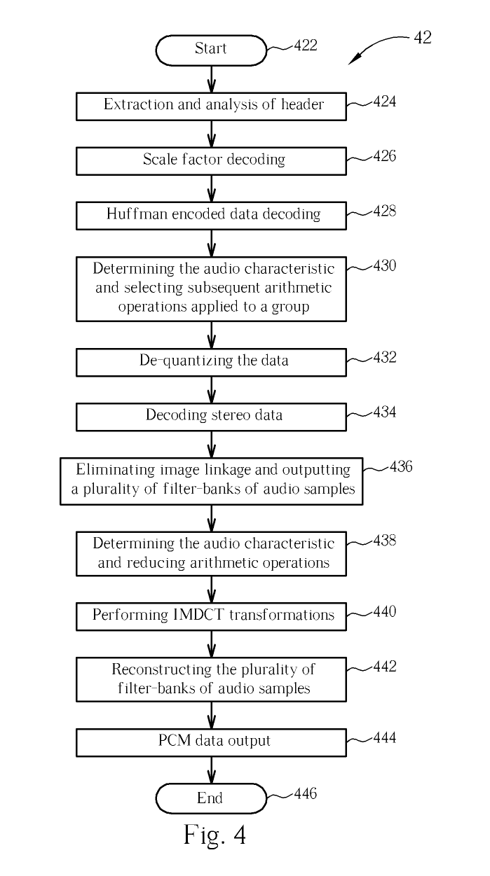

Please refer to FIG. 4 that is a flowchart 42 illustrating processing of MP3 decoding in FIG. 3. The flowchart 42 includes the following steps:

Step 422: Start.

Step 424: Extraction and analysis of header.

Step 426: Scale factor decoding.

Step 428: Huffman encoded data decoding.

Step 430: Determining the audio characteristic and selecting subsequent arithmetic operations applied to a group.

Step 432: De-quantizing the data.

Step 434: Decoding stereo data.

Step 436: Eliminating image linkage and outputting a plurality of filter-banks of audio samples.

Step 438: Determining the audio characteristic and reducing arithmetic operations of a filter-bank of the plurality of filter-banks.

Step 440: Performing inverse modified discrete cosine transformations on the plurality of filter-banks of audio samples.

Step 442: Reconstructing the plurality of filter-banks of audio samples.

Step 444: PCM data output.

Step 446: End.

The bit stream decomposer 31 extracts and analyzes the header of the received bit string (Step 424). The bit stream decomposer 31 decomposes the header of the received bit string into side information, a scale factor and Huffman encoded data (Step 424). The scale factor decoder 32 decodes the scale factor based on the side information (Step 426). The Huffman decoder 33 decodes the Huffman encoded data based on the side information (Step 428). The first operation simplification detector 34 is used for selecting subsequent arithmetic operations applied to a group outputted from the Huffman decoder 33 according to a predefined audio characteristic of the group. The first operation simplification detector 34 determines a first group of audio samples having a predefined audio characteristic outside a range running from a first predetermined value to a second predetermined value inclusive, determines a second group of audio samples having the predefined audio characteristic inside said range, and performs fewer arithmetic operations on the first group of audio samples than on the second group of audio samples (Step 430). In one embodiment of the present invention, the first predetermined value is less than 15 Hz and the second predetermined value is greater than 20000 Hz, which represents the frequency range insensitive to a human ear. In another embodiment of the present invention, the first predetermined value is less than 10 dB and the second predetermined value is greater than 130 dB, which represents the sound pressure level insensitive to a human ear. No subsequent arithmetic operations are performed on the first group of audio samples or fewer bits are used to represent the first group of audio samples than to represent the second group of audio samples. Furthermore, if a group of audio samples is detected providing all values of zero, processing no operations on the group of audio samples providing all values of zero.

Please keep on referring to FIG. 4. The de-quantizer 35 de-quantizes the Huffman encoded data based on the side information and the result of operations in step 430 (Step 432). The stereo decoder 36, in step 434, decodes stereo data outputted from the de-quantizer 35 based on the side information and the result of operations in step 430. The anti-aliasing device 37 eliminates image linkage outputted from the stereo decoder 36 based on the result of operations in step 430 and outputs a plurality of filter-banks of audio samples (Step 436). The second operation simplification detector 38 is used for selecting subsequent arithmetic operations applied to a filter-bank outputted from the anti-aliasing device 37 according to a predefined audio characteristic of the filter-bank. The second operation simplification detector 38 determines a first filter-bank of the plurality of filter-banks having the predefined audio characteristic outside said range, determines a second filter-bank of the plurality of filter-banks having the predefined audio characteristic inside said range, and performs fewer arithmetic operations on the first filter-bank than on the second filter-bank (Step 438). In one embodiment of the present invention, the first predetermined value is less than 15 Hz and the second predetermined value is greater than 20000 Hz, which represents the frequency range insensitive to a human ear. In another embodiment of the present invention, the first predetermined value is less than 10 dB and the second predetermined value is greater than 130 dB, which represents the sound pressure level insensitive to a human ear. No subsequent arithmetic operations are performed on the first filter-bank or fewer bits are used to represent the first filter-bank than to represent the second filter-bank. The IMDCT transformer 39 performs the inverse modified discrete cosine transformations on the plurality of filter-banks of audio samples outputted from the anti-aliasing device 37 based on the result of operations in step 438 (Step 440). The sub-band reconstruction device 40 reconstructs the plurality of filter-banks of audio samples outputted from the IMDCT transformer 39 based on the result of operations in step 438 (Step 442), and outputs a PCM data (Step 444).

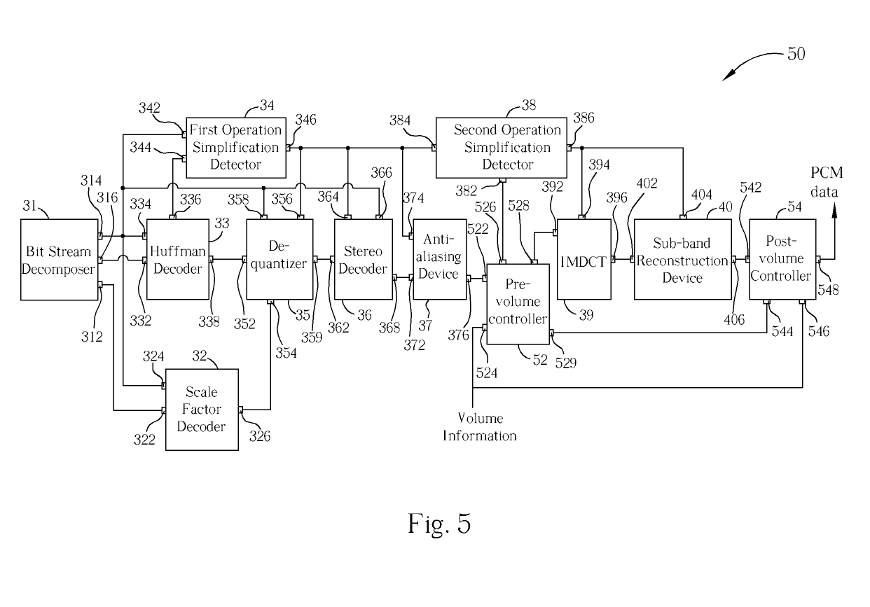

Please refer to FIG. 5. FIG. 5 is a diagram of another MP3 decoder 50 according to the present invention. The MP3 decoder 50 includes a bit stream decomposer 31, a scale factor decoder 32, a Huffman decoder 33, a first operation simplification detector 34, a de-quantizer 35, a stereo decoder 36, an anti-aliasing device 37, a second operation simplification detector 38, an IMDCT transformer 39, a sub-band reconstruction device 40, a pre-volume controller 52, and a post-volume controller 54. The bit stream decomposer 31, the scale factor decoder 32, the Huffman decoder 33, the first operation simplification detector 34, the de-quantizer 35, the stereo decoder 36, the anti-aliasing device 37, the second operation simplification detector 38, the IMDCT transformer 39, and the sub-band reconstruction device 40 operate in a manner similar to the MP3 decoder 30 described in FIG. 3. The difference between the MP3 decoder 50 and the MP3 decoder 30 is that the MP3 decoder 50 includes the pre-volume controller 52 and the post-volume controller 54. The anti-aliasing device 37 has a first input end 372 coupled to an output end 368 of the stereo decoder 36, a second input end 374 coupled to the output end 346 of the first operation simplification detector 34, and an output end 376 used to output a plurality of filter-bank samples. The pre-volume controller 52 has a first input end 522 coupled to the output end 376 of the anti-aliasing device 37, a second input end 524 used for receiving volume information, a first output end 526 coupled to a first input end 382 of the second operation simplification detector 38, a second output end 528 coupled to the first input end 392 of the inverse modified discrete cosine transformer 39, and a third output end 529 coupled to a second input end 544 of the post-volume controller 54. The first input end 382 of the second operation simplification detector 38 is coupled to the first output end 526 of the pre-volume controller 52 and a second input end 384 of the second operation simplification detector 38 is coupled to the output end 346 of the first simplification detector 34. The IMDCT transformer 39 has the first input end 392 coupled to the second output end 528 of the pre-volume controller 52 for receiving the filter-bank samples outputted from the pre-volume controller 52 and a second input end 394 coupled to an output end 386 of the second operation simplification detector 38. The sub-band reconstruction device 40 has a first input end 402 coupled to an output end 396 of the IMDCT transformer 39, a second input end 404 coupled to the output end 386 of the second operation simplification detector 38, and an output end 406 coupled to a third input end 546 of the post-volume controller 54. The post-volume controller 54 includes an output end 548 for outputting a PCM data. The post-volume controller 54 includes the first input end 542 coupled to the output end 406 of the sub-band reconstruction device 40, the second input end 544 coupled to the third output end 529 of the pre-volume controller 52, and a third input end 546 for receiving the volume information, and an output end 548 for outputting a PCM data.

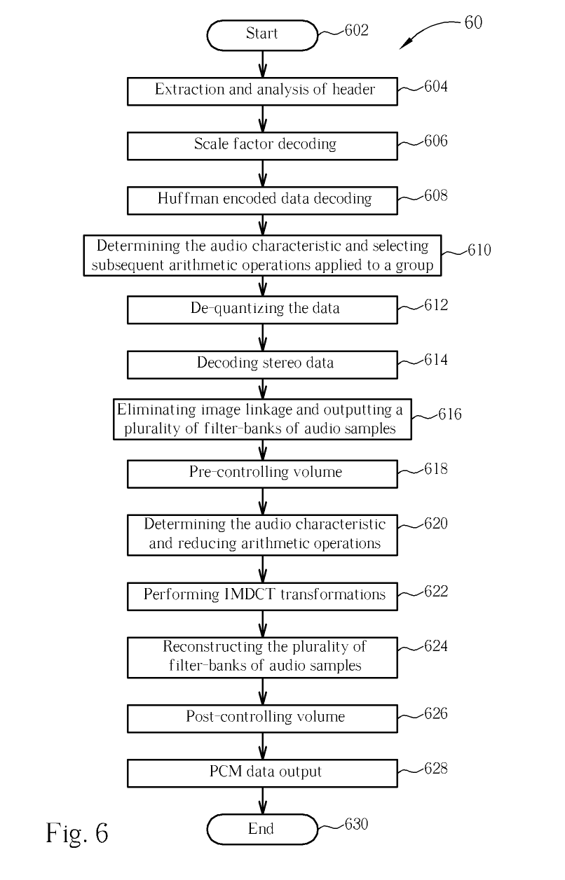

Please refer to FIG. 6 that is a flowchart 60 illustrating processing of MP3 decoding in FIG. 5. The flowchart 50 includes the following steps.

Step 602: Start.

Step 604: Extraction and analysis of header.

Step 606: Scale factor decoding.

Step 608: Huffman encoded data decoding.

Step 610: Determining the audio characteristic and selecting subsequent arithmetic operations applied to a group.

Step 612: De-quantizing the data.

Step 614: Decoding stereo data.

Step 616: Eliminating image linkage and outputting a plurality of filter-banks of audio samples.

Step 618: Pre-controlling volume of the plurality of filter-banks of audio samples.

Step 620: Determining the audio characteristic and reducing arithmetic operations of a filter-bank of the plurality of filter-banks.

Step 622: Performing inverse modified discrete cosine transformations on the plurality of filter-banks of audio samples.

Step 624: Reconstructing the plurality of filter-banks of audio samples.

Step 626: Post-controlling volume of the plurality of filter-banks of audio samples.

Step 628: PCM data output.

Step 630: End.

Steps 602-616 are the same as steps 422-436 described in FIG. 4. Deserving to be mentioned is that the pre-volume controller 52 controls volume of the plurality of filter-banks of audio samples according to volume information before the second operation simplification detector 38 performs the arithmetic operations (Step 618). The pre-volume controller 52 controls volume of the plurality of filter-banks of audio samples outputted from the anti-aliasing device 37 and sends the result to the second operation simplification detector 38 and the post-volume controller 54 based on a particular algorithm. Due to step 618, the performance of the second operation simplification detector 38 can be improved.

The second operation simplification detector 38 is used for selecting subsequent arithmetic operations applied to a filter-bank outputted from the pre-volume controller 52 according to a predefined audio characteristic of the filter-bank. The second operation simplification detector 38 determines a first filter-bank of the plurality of filter-banks having the predefined audio characteristic outside said range, determines a second filter-bank of the plurality of filter-banks having the predefined audio characteristic inside said range, and performs fewer arithmetic operations on the first filter-bank than on the second filter-bank (Step 620). In one embodiment of the present invention, the first predetermined value is less than 15 Hz and the second predetermined value is greater than 20000 Hz, which represent the frequency range insensitive to a human ear. In another embodiment, the first predetermined value is less than 10 dB and the second predetermined value is greater than 130 dB, which represent the sound pressure level insensitive to a human ear. No subsequent arithmetic operations are performed on the first filter-bank or fewer bits are utilized to represent the first filter-bank than to represent the second filter-bank.

The IMDCT transformer 39 performs the inverse modified discrete cosine transformations on the plurality of filter-banks of audio samples outputted from the pre-volume controller 52 based on the result of operations in step 620. The sub-band reconstruction device 40 reconstructs the plurality of filter-banks of audio samples outputted from the IMDCT transformer 39 based on the result of operations in step 622. The post-volume controller 54 controls volume of the plurality of filter-banks of audio samples outputted from the sub-band reconstruction device 40 according to volume information and the result of operations in step 618 (Step 626). Finally, the post-volume controller 54 outputs a PCM data (Step 628).

Please keep referring to FIG. 5 and FIG. 6. In the prior art, no operations are performed on only the group of audio samples providing all values of zero. But in this embodiment of our invention, the first operation simplification detector 34 can find out more groups of audio samples that are insensitive to a human ear and/or have no encoded data according to the side information. The second operation simplification detector 38 can find out more filter-banks of audio samples that are insensitive to a human ear according to specific algorithms and/or have no encoded data according to the information from the first operation simplification detector 34. The pre-volume controller 52 and the post-volume controller 54 can help the second operation simplification detector 38 to find out more and more filter-banks of audio samples that are insensitive to a human ear. By way of utilizing the first operation simplification detector 34, the second operation simplification detector 38, the pre-volume controller 52, and the post-volume controller 54, we can reduce more operations.

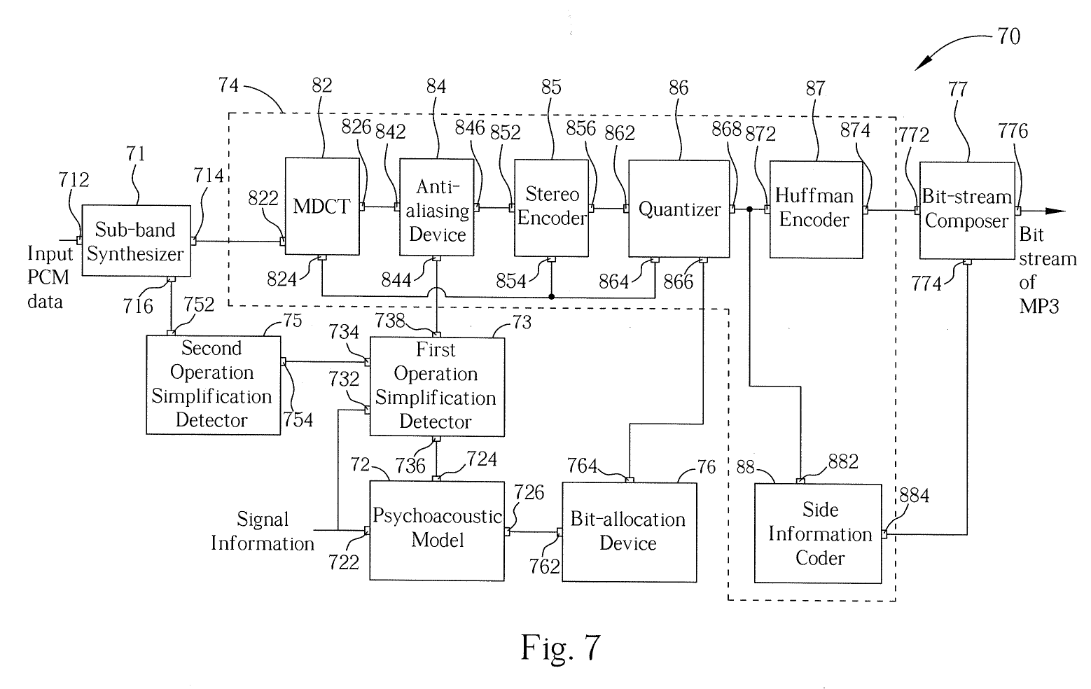

Please refer to FIG. 7. FIG. 7 is a diagram of an MP3 encoder 70 according to the present invention. The MP3 encoder 70 includes a sub-band synthesizer 71, a psychoacoustic model 72, a first operation simplification detector 73, an encoder 74, a second operation simplification detector 75, a bit-allocation device 76, and a bit stream composer 77. The encoder 74 includes an MDCT transformer 82, an anti-aliasing device 84, a stereo encoder 85, a quantizer 86, a Huffman encoder 87, and a side information coder 88. The sub-band synthesizer 71 has an input end 712 for receiving input PCM data, a first output end 714 and a second output end 716 for outputting a plurality of filter-bank samples. The second operation simplification detector 75 has an input end 752 coupled to the output end 716 of the sub-band synthesizer 71. The second operation simplification detector 75 is used for selecting subsequent arithmetic operations applied to a filter-bank of the plurality of filter-bank samples according to a predefined audio characteristic of the filter-bank. The psychoacoustic model 72 includes an input end 722 for receiving signal information. The first operation simplification detector 73 has a first input end 732 for receiving signal information, a second input end 734 coupled to an output end 754 of the second operation simplification detector 75, and a third input end 736 coupled to a first output end 724 of the psychoacoustic model 72. The MDCT transformer 82 has a first input end 822 coupled to the first output end 714 of the sub-band synthesizer 71 and a second input end 824 coupled to an output end 738 of the first operation simplification detector 73. The anti-aliasing device 84 includes a first input end 842 coupled to an output end 826 of the MDCT transformer 82 and a second input end 844 coupled to the output end 738 of the first operation simplification detector 73. The stereo encoder 85 includes a first input end 852 coupled to an output end 846 of the anti-aliasing device 84 and a second input end 854 coupled to the output end 738 of the first operation simplification detector 73. The quantizer 86 includes a first input end 862 coupled to an output end of the stereo encoder 85, a second input end 864 coupled to the output end 738 of the first operation simplification detector 73, and a third input end coupled to an output end 766 of the bit-allocation device 76. The Huffman encoder 87 includes an input end 872 coupled to an output end 868 of the quantizer 86. The side information coder 88 includes an input end 882 coupled to the output end 868 of the quantizer 86 and an output end 884 coupled to a second input end 774 of the bit stream composer 77. The bit-allocation device 76 includes an input end 762 coupled to an output end 726 of the psychoacoustic model 72 and an output end 764 coupled to the third input end 866 of the quantizer 86. The bit stream composer 77 includes a first input end 772 coupled to an output end 874 of the Huffman encoder 87 and an output end 776 for outputting a bit stream of MP3. The bit stream composer 77 is used to compose a Huffman data and the side information into the bit stream of MP3.

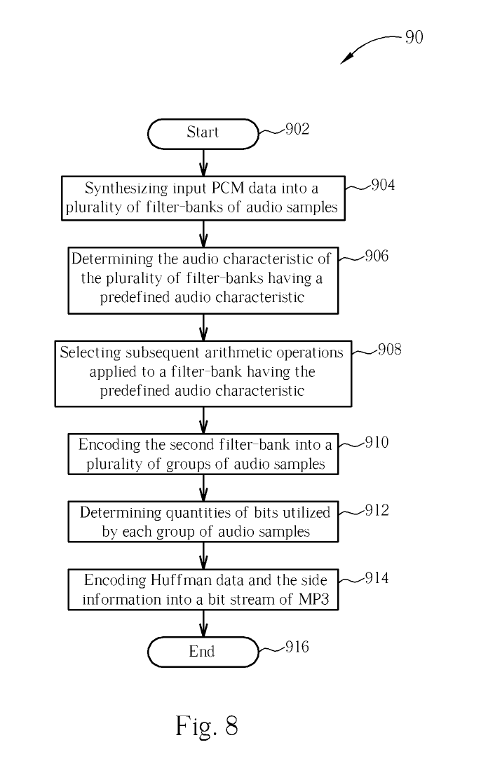

Please refer to FIG. 8 that is a flowchart 90 illustrating processing of MP3 encoding in FIG. 7. The flowchart 90 includes the following steps.

Step 902: Start.

Step 904: Synthesizing input PCM data into a plurality of filter-banks of audio samples.

Step 906: Determining the audio characteristic of the plurality of filter-banks having a predefined audio characteristic.

Step 908: Selecting subsequent arithmetic operations applied to a filter-bank having the predefined audio characteristic.

Step 910: Encoding the second filter-bank into a plurality of groups of audio samples.

Step 912: Determining quantities of bits utilized by each group of audio samples.

Step 914: Encoding Huffman data and the side information into a bit stream of MP3.

Step 916: End.

The sub-band synthesizer 71 synthesizes input PCM data into the plurality of filter-banks of audio samples (Step 904). The second operation simplification detector 75 and the first operation simplification detector 73 perform steps 906-908. The second operation simplification detector 75 performs zero searching. The second operation simplification detector 75 determines reducing arithmetic operations on which filter-bank of the plurality of filter-banks according to information from the psychoacoustic model 72. The first operation simplification detector 73 determines a first filter-bank of the plurality of filter-banks having a predefined audio characteristic less than a first predetermined value or greater than a second predetermined value and a second filter-bank of the plurality of filter-banks having the predefined audio characteristic between the first predetermined value and the second predetermined value inclusive according to the signal information, information from the psychoacoustic model 72 and the second operation simplification detector 75. The first predetermined value is less than the second predetermined value. The first operation simplification detector 73 performs fewer arithmetic operations on the first filter-bank than on the second filter-bank of the plurality of filter-banks. No subsequent arithmetic operations are performed on the first filter-bank or fewer bits are used to represent the first filter-bank than to represent the second filter-bank. Furthermore, if a third filter-bank of the plurality of filter-banks providing all values of zero is detected, no subsequent arithmetic operations are processed on the third filter-bank. The bit-stream composer 77 encodes Huffman data and the side information into the bit stream of MP3.

Please keep on referring to FIG. 8. In step 910, encoding the second filter-bank into the plurality of groups of audio samples includes the following steps.

Step 922: Performing modified discrete cosine transformations on the plurality of filter-banks of audio samples.

Step 924: Eliminating image linkage.

Step 926: Encoding stereo data.

Step 928: Quantizing the filter-bank of audio samples.

Step 930: Encoding data into the Huffman data.

Step 932: Encoding data into the side information.

The MDCT transformer 82 performs modified discrete cosine transformations on the second filter-bank of audio samples after the first operation simplification detector 73 determines that the second filter-bank is a second filter-bank (Step 922). The anti-aliasing device 84 eliminates image linkage after the first operation simplification detector 73 determines that the second filter-bank is a second filter-bank (Step 924). The stereo encoder 85 encodes stereo data after the first operation simplification detector 73 determines that the second filter-bank is a second filter-bank (Step 926). The quantizer 86 quantizes the filter-bank samples after the first operation simplification detector 73 determines that the second filter-bank is a second filter-bank (Step 928). The Huffman encoder 87 encodes data into the Huffman data (Step 930). The side information coder encodes data into the side information (Step 932).

Please keep referring to FIG. 7 and FIG. 8. In the prior art, no operations are performed on only the group of audio samples providing all values of zero. But in this embodiment of our invention, the second operation simplification detector 75 determines reducing arithmetic operations on which filter-bank of the plurality of filter-banks according to information from the psychoacoustic model 72. The first operation simplification detector 73 determines a first filter-bank of the plurality of filter-banks having a predefined audio characteristic less than a first predetermined value or greater than a second predetermined value and a second filter-bank of the plurality of filter-banks having the predefined audio characteristic between the first predetermined value and the second predetermined value inclusive according to the signal information, information from the psychoacoustic model 72 and the second operation simplification detector 75. For example, if a frequency of a filter-bank of the plurality of filter-banks is less than 15 Hz or greater than 20000 Hz, which represents the frequency range insensitive to a human ear. Hence, the first operation simplification detector 73 regards the filter-bank as insensitive to a human ear according to the signal information, information from the psychoacoustic model 72 and the second operation simplification detector 75. By way of utilizing the second operation simplification detector 75 and the first operation simplification detector 73, we can reduce more operations.

The above-mentioned embodiments illustrate but do not limit the present invention. The first operation simplification detector and the second operation simplification detector can be applied to an MP3 decoder to improve the processing of MP3 decoding at the same time or independently. Similarly, the first operation simplification detector and the second operation simplification detector can be applied to an MP3 encoder to improve the processing of MP3 encoding at the same time or independently. Furthermore, controlling the volume of the plurality of filter-banks of audio samples according to volume information before performing inverse modified discrete cosine transformations on the filter-banks of audio samples can be applied to the MP3 decoder selectively.

In conclusion, the present invention provides a method and related device for improving the processing of MP3 decoding and encoding. When performing inverse modified discrete cosine transformations on the filter-banks of audio samples, no subsequent arithmetic operations are processed on the group of audio samples providing all values of zero, fewer arithmetic operations are processed on the first group of audio samples, or fewer bits are utilized to represent the first group of audio samples than to represent the second group of audio samples. Moreover, controlling the volume of the plurality of filter-banks of audio samples according to volume information before performing inverse modified discrete cosine transformations on the filter-banks of audio samples improves efficiency of decoding. Additionally, if it is determined that a first filter-bank of the plurality of filter-banks has a predefined audio characteristic less than a first predetermined value or greater than a second predetermined value, fewer arithmetic operations are performed on the first filter-bank than on a second filter-bank of the plurality of filter-banks having the predefined audio characteristic between the first predetermined value and the second predetermined value inclusive. When performing modified discrete cosine transformations on the filter-banks of audio samples, no subsequent arithmetic operations are performed on the first filter-bank, fewer bits are utilized to represent the first filter-bank than to represent the second filter-bank, and no subsequent arithmetic operations are performed on the third filter-bank that provides all values of zero. The claimed invention improves both efficiency of decoding and encoding. This especially works well on processor such as an ARM CPU or DSP using double precision multiplication.

Those skilled in the art will readily observe that numerous modifications and alterations of the device and method may be made while retaining the teachings of the invention. Accordingly, the above disclosure should be construed as limited only by the metes and bounds of the appended claims.

1. A method for improving the processing of MP3 decoding, the method comprising:
decoding Huffman encoded data into audio samples according to side information;
determining a first group of audio samples having a predefined audio characteristic outside a range running from a first predetermined value to a second predetermined value inclusive;
determining a second group of audio samples having the predefined audio characteristic inside said range; and
performing fewer arithmetic operations on the first group of audio samples than on the second group of audio samples.

2. The method of claim 1 wherein no subsequent arithmetic operations are performed on the first group of audio samples.

3. The method of claim 1 wherein performing fewer arithmetic operations on the first group of audio samples comprises using fewer bits to represent the first group of audio samples than to represent the second group of audio samples.

4. The method of claim 1 further comprising:
decoding stereo data;
eliminating image linkage and outputting a plurality of filter-banks of audio samples;
determining a first filter-bank of the plurality of filter-banks having the predefined audio characteristic outside said range;
determining a second filter-bank of the plurality of filter-banks having the predefined audio characteristic inside said range; and
performing fewer arithmetic operations on the first filter-bank than on the second filter-bank.

5. The method of claim 4 wherein no subsequent arithmetic operations are performed on the first filter-bank.

6. The method of claim 4 wherein performing fewer arithmetic operations on the first filter-bank comprises using fewer bits to represent the first filter-bank than are used to represent the second filter-bank.

7. The method of claim 4 further comprising controlling volume of the plurality of filter-banks of audio samples before performing the arithmetic operations.

8. An MP3 decoder capable of improving the processing of MP3 decoding, the MP3 decoder comprising:
a bit stream decomposer for decomposing an input bit stream of MP3 into side information, a scale factor and Huffman encoded data;
a scale factor decoder, having a first input end coupled to a first output end of the bit stream decomposer for receiving the scale factor, and a second input end coupled to a second output end of the bit stream decomposer for receiving the side information;
a Huffman decoder having a first input end coupled to a third output end of the bit stream decomposer for receiving the Huffman encoded data, and a second input end coupled to the second output end of the bit stream decomposer for receiving the side information;
a first operation simplification detector, having a first input end coupled to the second output end of the bit stream decomposer for receiving the side information and a second input end coupled to a first output end of the Huffman decoder, the first operation simplification detector used for selecting subsequent arithmetic operations applied to a group outputted from the Huffman decoder according to a predefined audio characteristic of the group; and
a de-quantizer, having a first input end coupled to a second output end of the Huffman decoder, a second input end coupled to an output end of the scale factor decoder, a third input end coupled to an output end of the first operation simplification, and a fourth input end coupled to the second output end of the bit stream decomposer for receiving the side information.

9. The MP3 decoder of claim 8 further comprising:
a stereo decoder, having a first input end coupled to an output end of the de-quantizer, a second input end coupled to the output end of the first operation simplification detector, and a third input end coupled to the second output end of the bit stream decomposer; and
an anti-aliasing device, having a first input end coupled to an output end of the stereo decoder, a second input end coupled to the output end of the first operation simplification detector, and an output end used to output a plurality of filter-bank samples.

10. The MP3 decoder of claim 8 further comprising:
a pre-volume controller, having a first input end coupled to the output end of the anti-aliasing device, a second input end used for receiving a volume information, a first output end coupled to the first input end of second operation simplification detector, and a second output end coupled to the first input end of the inverse modified discrete cosine transformer; and
a post-volume controller, having a first input end coupled to the output end of the sub-band reconstruction device, a second input end coupled to a third output end of the pre-volume controller, and a third input end used to receive the volume information.

11. A method for improving the processing of MP3 decoding, the method comprising:
decoding Huffman encoded data according to side information;
eliminating image linkage and outputting a plurality of filter-banks of audio samples;
determining a first filter-bank of the plurality of filter-banks having a predefined audio characteristic less than a first predetermined value or greater than a second predetermined value; and
performing fewer arithmetic operations on the first filter-bank than on a second filter-bank of the plurality of filter-banks having the predefined audio characteristic between the first predetermined value and the second predetermined value inclusive;
wherein the first predetermined value is less than the second predetermined value.

12-18. (canceled)

19. An MP3 decoder comprising:
a bit stream decomposer having a first output end, a second output end, and a third output end;
a scale factor decoder having a first input end coupled to the first output end of the bit stream decomposer, and a second input end coupled to the second output end of the bit stream decomposer;
a Huffman decoder having a first input end coupled to the third output end of the bit stream decomposer, and a second input end coupled to the second output end of the bit stream decomposer; and
a first operation simplification detector having a first input end coupled to the second output end of the bit stream decomposer, and a second input end coupled to a first output end of the Huffman decoder;
wherein the first operation simplification detector selects subsequent arithmetic operations applied to a group of audio data outputted from the Huffman decoder according to a predefined audio characteristic of the group.

20. The MP3 decoder of claim 19 further comprising:
a de-quantizer having a first input end coupled to a second output end of the Huffman decoder, a second input end coupled to an output end of the scale factor decoder, a third input end coupled to an output end of the first operation simplification detector, and a fourth input end coupled to the second output end of the bit stream decomposer;
a stereo decoder having a first input end coupled to an output end of the de-quantizer, a second input end coupled to the output end of the first operation simplification detector, and a third input end coupled to the second output end of the bit stream decomposer;
an anti-aliasing device having a first input end coupled to an output end of the stereo decoder, a second input end coupled to the output end of the first operation simplification detector;
an inverse modified discrete cosine transformer; and
a pre-volume controller having a first input end coupled to an output end of the anti-aliasing device, a second input end used for receiving volume information, a first output end coupled to a first input end of the inverse modified discrete cosine transformer.

21. The MP3 decoder of claim 20 further comprising:
a second operation simplification detector having a first input end coupled to the output end of the first operation simplification detector, a second input end coupled to a second output end of the pre-volume controller, and an output end coupled to a second input end of the inverse modified discrete cosine transformer.

22. The MP3 decoder of claim 21 further comprising:
a sub-band reconstruction device having a first input end coupled to an output end of the inverse modified discrete cosine transformer, and a second input end coupled to the output of the second operation simplification detector; and
a post-volume controller having an output end for outputting PCM data, a first input end coupled to an output end of the sub-band reconstruction device, a second input end coupled to a third output end of the pre-volume controller, and a third input end for receiving the volume information.

23. An MP3 encoder comprising:
a sub-band synthesizer having an input end for receiving input PCM data, a first output end, and a second output end;
a second operation simplification detector having an input end coupled to the first output end of the sub-band synthesizer;
a psychoacoustic model having an input end for receiving signal information;
a first operation simplification detector having a first input end for receiving the signal information, a second input end coupled to an output end of the second operation simplification detector, and a third input end coupled to a first output end of the psychoacoustic model;
a bit-allocation device having an input coupled to a second output of the psychoacoustic model; and
an encoder module coupled to the second output end of the sub-band synthesizer, coupled to an output of the first operation simplification detector, coupled to an output of the bit-allocation device, and coupled to both a first and a second input of a bit-stream composer.

24. The MP3 encoder of claim 23 wherein the second operation simplification detector performs zero searching and determines reducing arithmetic operations on which filter-bank of the plurality of filter-banks according to information from the psychoacoustic model, the first operation simplification detector determines a first filter-bank of the plurality of filter-banks having a predefined audio characteristic less than a first predetermined value or greater than a second predetermined value and a second filter-bank of the plurality of filter-banks having the predefined audio characteristic between the first predetermined value and the second predetermined value inclusive according to the signal information, information from the psychoacoustic model and the second operation simplification detector.
